(19) United States
(12) Patent Application Publication
(10) Pub. No.: US 2012/0268663 A1
(43) Pub. Date: Oct. 25, 2012

(54) ILLUMINATION DEVICE, DISPLAY DEVICE, AND TELEVISION RECEPTION DEVICE

(75) Inventor: Hiroshi Kunii, Osaka (JP)

(73) Assignee: SHARP KABUSHIKI KAISHA, Osaka (JP)

(21) Appl. No.: 13/516,485

(22) PCT Filed: Nov. 5, 2010
(86) PCT No.: PCT/JP2010/069672

§ 371 Date: Jun. 26, 2012

(30) Foreign Application Priority Data
Dec. 16, 2009 (JP) 2009-285342

(51) Int. Cl. F21V 21/00; G02F 1/13357; H04N 5/66; G09F 13/04

(52) U.S. Cl. 348/739; 362/382; 362/97.1; 362/97.2; 348/E05.133

(57) ABSTRACT

An object of the present invention is to prevent damage that occurs in attaching a power supply board to connectors in an illumination device. An illumination device according to the present invention is an illumination device including a light source 17, a chassis 14 that houses the light source 17, a power supply board 30 that is disposed on the chassis 14 on the side opposite to the light source 17 and that supplies driving power to the light source 17, and relay connectors 20 that are attached to the chassis 14 and that relay the power supply from the power supply board 30 to the light source 17, wherein the power supply board 30 can be inserted into and removed from the relay connectors 20 in a direction along the plane of this board 30, and includes terminals 32, which are to be electrically connected to the respective relay connectors 20, on the front end thereof in the insertion direction into the relay connectors 20 and connector contact portions 34 that contact, preceding to the terminals 32, the side walls of the corresponding relay connectors 20 along the insertion direction of the power supply board 30 so as to guide the insertion of the terminals 32 into the relay connectors 20 when this power supply board 30 is inserted into the relay connectors 20.

### TECHNICAL FIELD

The present invention relates to an illumination device, a display device, and a television reception device.

### BACKGROUND ART

A liquid crystal panel used in a liquid crystal display device such as a liquid crystal television, for example, does not emit light itself and therefore requires a backlight device separately as an illumination device. This backlight device is installed on the rear side (on the side opposite to the display surface) of the liquid crystal panel, and includes a chassis that has an opening toward the side of the liquid crystal panel, a plurality of lamps (such as cold cathode tubes) housed in the chassis, and an inverter unit capable of supplying power to each lamp.

The configuration described in Patent Document 1 below is known as one example of a configuration for connecting the inverter unit to the lamps. In this configuration, the lamps are disposed on the front side of the chassis, which is the inside, while the inverter unit is disposed on the rear side of the chassis, which is the outside, and lamp sockets are attached to the chassis so as to pass through the chassis. The lamps are respectively connected to the inner end portions of these lamp sockets, while the inverter unit is connected to the outer end portions of the lamp sockets. The respective lamp sockets have fixing holes that hold the inverter unit by sandwiching it with spring members, and protruding portions that correspond to these fixing holes are formed on the inverter unit.

In the liquid crystal display device disclosed in the aforementioned Patent Document 1, the inverter unit is connected to the lamp sockets by sliding the inverter unit horizontally in a direction orthogonal to the lamp socket array direction while placing the inverter unit so as to face the rear surface of the chassis, and by inserting the protruding portions of the inverter unit into the fixing holes of the lamp sockets. This way, the inverter unit affixed to the lamp sockets.

### RELATED ART DOCUMENTS

### Patent Documents

Patent Document 1: Japanese Patent Application Laid-Open Publication No. 2009-26748

### Problems to be Solved by the Invention

However, with such a structure, when the inverter unit is caused to slide horizontally in a direction orthogonal to the lamp socket array direction, the movement of the inverter unit is not restricted to the sliding direction. Therefore, a misalignment of the inverter unit is likely to occur such as the inverter unit being tilted relative to the insertion direction into the lamp sockets. If an attempt is made to connect the inverter unit forcibly to the lamp sockets when the inverter unit is misaligned, the inverter unit and the lamp sockets may be damaged.

### SUMMARY OF THE INVENTION

The present invention was made in view of the aforementioned circumstances, and an object thereof is to prevent damage that occurs in connecting relay connectors to a power supply board.

### Means for Solving the Problems

The present invention is an illumination device including a light source, a chassis that houses the light source, a power supply board that is disposed on the chassis on the side opposite to the light source and that supplies driving power to the light source, and relay connectors that are attached to the chassis and that relay a supply of power from the power supply board to the light source, wherein the power supply board can be inserted into and removed from the relay connectors in a direction along a plane of the board, and includes terminals, which are to be electrically connected to the relay connectors, respectively, on a front end of said power supply board in an insertion direction into the relay connectors and connector contact portions that make contact with, preceding to the terminals, side walls of the respective said relay connectors along the insertion direction of the power supply board so as to guide the insertion of the terminals into the relay connectors when the power supply board is inserted into the relay connectors.

With such a configuration, when the power supply board is inserted into the relay connectors such that power is supplied to the light source from the power supply board via the relay connectors, the connector contact portions make contact with, preceding to the terminals provided on the power supply board, the side walls of the relay connectors along the insertion direction of the power supply board, and this contact makes it possible to guide the power supply board to the insertion direction into the relay connectors. Consequently, it is possible to restrict the movement of the power supply board so as not to move in any other directions along the plane of the board than the insertion direction, thus making it possible to prevent damage to the respective members, which would be caused when the power supply board is inserted into the relay connectors with a positional misalignment.

Because the relay of power, which is the principal function of the relay connectors, is achieved by the electrical connection between the terminals of the power supply board and the relay connectors, it is understood that preventing damage to the terminals of the power supply board is the most important object. Thus, in the present invention, the power supply board is provided with the connector contact portions on the front side of the terminals in the insertion direction into the relay connectors such that the insertion of the board is guided by these connector contact portions. This prevents or suppresses the movement of the power supply board in directions different from the insertion direction, thereby suppressing the occurrence of the problem of the terminals and the relay connectors contacting another member and getting damaged.

Preferable embodiments of the present invention are as follows:

(1) The connector contact portions are constituted of the inner edge portions of holes that have been formed by punching the power supply board, and by having the relay connectors respectively inserted through these holes, the power supply board and the relay connectors are properly positioned in a direction that intersects with the insertion direction thereof. With such a configuration, by inserting the relay connectors through the holes that constitute the connector contact portions first, an approximate alignment of the power supply board to the relay connectors can be performed. Further, by configuring the connector contact portions using the punched holes (to be exact, the inner edge portions thereof), the strength of the connector contact portions can be increased. Moreover, because the connector contact portions are formed of the inner edge portions of the holes, in contrast to the case where protruding pieces that protrude beyond the end portion of the board are used as the connector contact portions, there is no need to add sharp angular portions to the board, allowing for better handling during work.

(2) The connector contact portions are constituted of a plurality of protruding portions that protrude in the direction in which the power supply board is inserted into the relay connectors. By constituting the connector contact portions from the plurality of protruding portions, the extending length of the protruding portions can be selected freely as compared with the above-mentioned case of utilizing the inner edge portions of the holes. Specifically, when the connector contact portions are formed of the inner edge portions of the holes, it is necessary to make these holes large enough to allow for the insertion of the relay connectors. In contrast, when the connector contact portions are constituted of the protruding portions, the power supply board can be inserted into the relay connectors without having the relay connectors inserted through the connector contact portions. Therefore, by forming the connector contact portions of protruding portions that are shorter than the dimension of the side walls of the relay connectors along the insertion direction of the power supply board, for example, the size of the power supply board can be reduced, and the material cost can therefore be reduced.

(3) The connector contact portions are respectively provided for the corresponding relay connectors. By providing the connector contact portions respectively (one by one) for the corresponding relay connectors, it becomes possible to improve the accuracy in guiding the power supply board to the insertion direction into the relay connectors, and as a result, the power supply board can be attached to the relay connectors more accurately. In addition, when a plurality of holes (to be exact, the inner edge portions thereof), which correspond to the number of the relay connectors, are used as the connector contact portions, a portion to be punched out to form the holes can be divided into smaller segments, and therefore, the strength of the connector contact portions is increased.

(4) The connector contact portions are formed in a portion of the power supply board that is extended beyond the front end of the terminals in the direction in which the board is inserted into the relay connectors. When the connector contact portions are formed in the portion of the power supply board that is extended beyond the terminals in the direction in which the board is inserted into the relay connectors, a larger board thickness can be ensured around the terminals, and therefore, the strength of the terminals is increased.

(5) Each of the relay connectors includes a board housing portion that can house the power supply board therein. The board housing portion is open in one of the two directions orthogonal to the direction in which the power supply board is inserted into the relay connector on the plane of the power supply board, and is closed in at least the other one of such two directions and on a side facing the chassis. In the board housing portion of the relay connector, a pair of elastic pieces that can establish an electrical connection while elastically clamping the terminal are provided at positions that face the terminal when the power supply board and the relay connectors engage each other. The connector contact portions provided in the power supply board can be suitably used for an illumination device equipped with the relay connectors having such a configuration in particular.

(6) The relay connectors are plurally disposed so as to be aligned along at least one side of the chassis, and the openings of the board housing portions of the respective relay connectors are facing in the same direction. In such a structure, the power supply board to be inserted may be moved in the direction in which the openings of the board housing portions of the relay connectors are facing, and therefore, the power supply board is more likely to be misaligned to the relay connectors when the power supply board is inserted into the relay connectors. In contrast, the connector contact portions provided in the power supply board of the present invention can prevent the power supply board from moving in other directions along the plane of the board than the insertion direction and can therefore be suitably used for an illumination device having such relay connectors in particular.

(7) In the board housing portion, an inviting surface having an inclination that guides the power supply board to the interior of the board housing portion is formed inside of an edge of the opening on the side from which the power supply surface is inserted. This makes it easier to insert the power supply board into the board housing portions, which can improve work efficiency.

Next, in order to solve the aforementioned problems, a display device of the present invention includes any one of the illumination devices described above and a display panel that performs display by utilizing light from the aforementioned illumination device. In such a display device, it is possible to suppress the occurrence of damage in an assembly process of the illumination device that supplies light to the display panel, and therefore, the manufacturing cost is reduced, and operational reliability is improved.

A liquid crystal panel is an example of the aforementioned display panel. Such a display device can be applied to various usages such as displays for televisions and computers as a liquid crystal display device, and is suitably used for a large screen in particular.

A television reception device of the present invention preferably includes the display device described above. With such a television reception device, it is possible to provide a device that can reduce the manufacturing cost and that has superior operational reliability.

### Effects of the Invention

According to the present invention, it is possible to prevent damage that occurs in a step of attaching the power supply board to the relay connectors.

### BRIEF DESCRIPTION OF THE DRAWINGS

FIG. 1 is an exploded perspective view showing a schematic configuration of the television reception device according to Embodiment 1 of the present invention.

FIG. 2 is a sectional view showing the configuration of a section along the direction of the long side of a liquid crystal display device.

FIG. 3 is a plan view of a chassis that houses cold cathode tubes.

FIG. 4 is a bottom view of the chassis having inverter boards attached thereto.

FIG. 5 is a perspective view of a relay connector.

FIG. 6 is a side view of the relay connector on the side from which an inverter board is inserted.

FIG. 7 is a side view of the relay connector on the side along the direction of the long side of the liquid crystal display device.

FIG. 8 is an enlarged plan view of an inverter board.

FIG. 9 is a partial perspective view immediately before the insertion of the inverter board into the relay connectors.

FIG. 10 is a partial plan view immediately before the insertion of the inverter board into the relay connectors.

FIG. 11 is a partial perspective view showing the inverter board sandwiched by the relay connectors.

FIG. 12 is a partial plan view showing the inverter board sandwiched by the relay connectors.

FIG. 13 is a sectional view along the line A-A in FIG. 12.

FIG. 14 is a partial plan view immediately before the inverter board according to Embodiment 2 of the present invention is inserted into the relay connectors.

FIG. 15 is a partial plan view showing the inverter board according to Embodiment 2 of the present invention sandwiched by the relay connectors.

FIG. 16 is a partial plan view immediately before the inverter board according to Embodiment 3 of the present invention is inserted into the relay connectors.

FIG. 17 is a partial plan view showing the inverter board according to Embodiment 3 of the present invention sandwiched by the relay connectors.

### DETAILED DESCRIPTION OF EMBODIMENTS

### Embodiment 1

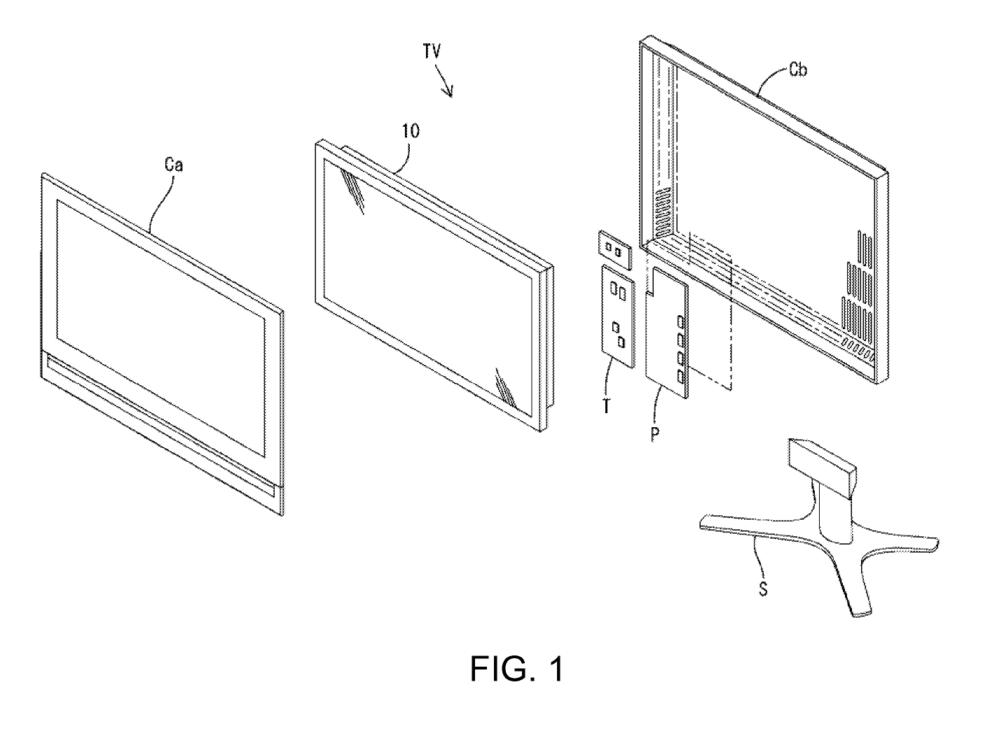

Embodiment 1 of the present invention will be described with reference to FIGS. 1 to 3. In the present embodiment, a liquid crystal display device 10 is described as an example.

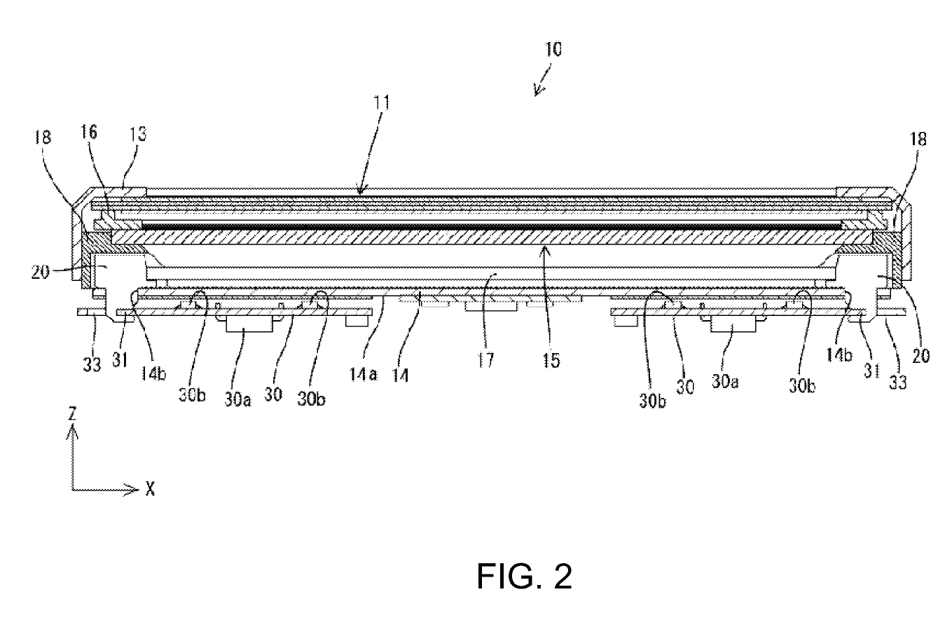

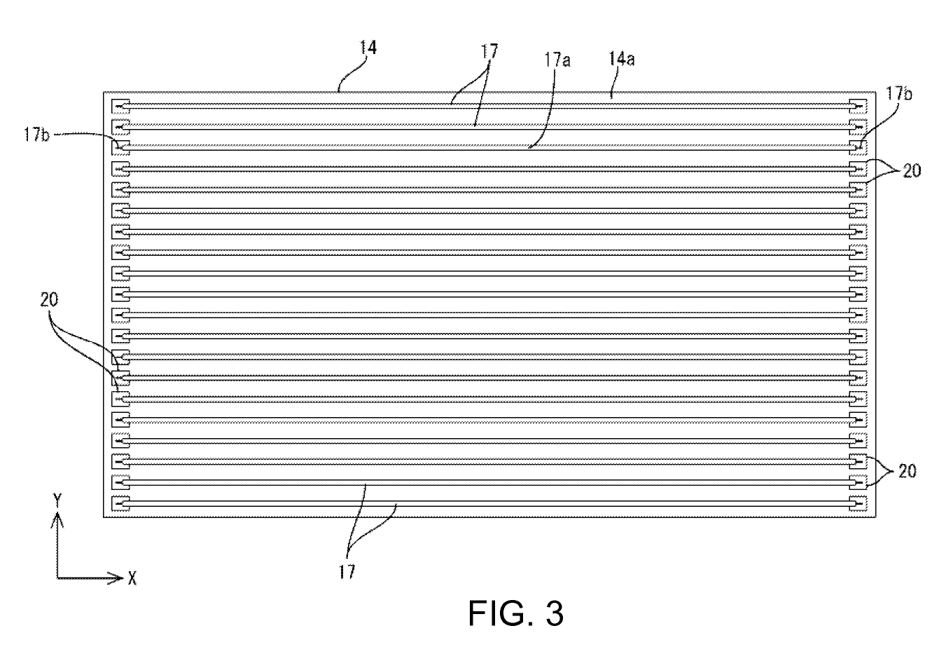

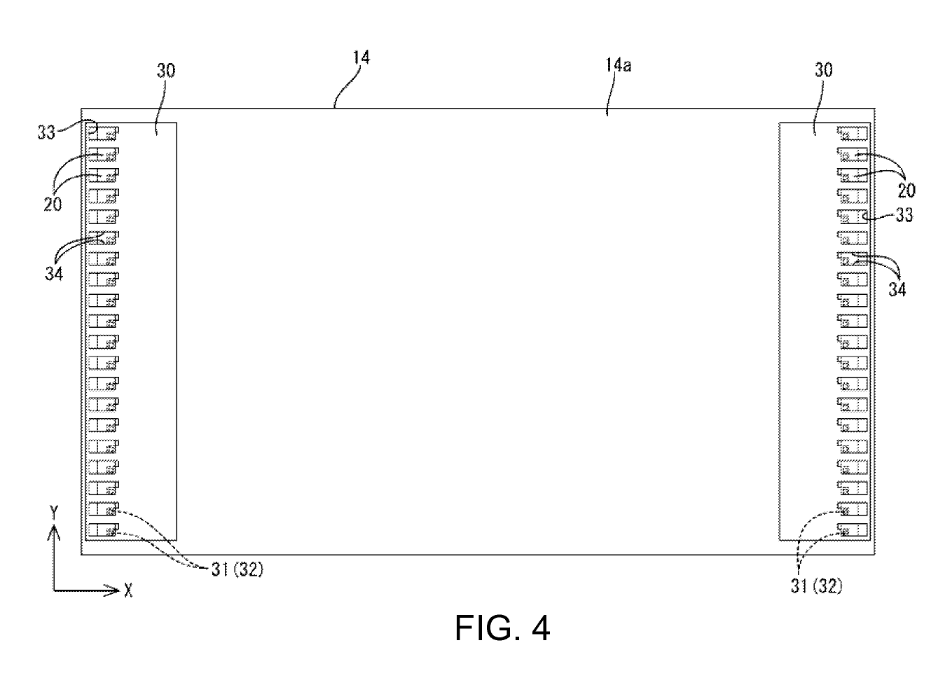

FIG. 1 shows an exploded perspective view illustrating a schematic configuration of the television reception device according to the present embodiment, FIG. 2 shows a sectional view illustrating the configuration of a cross section along the direction of the long side of the liquid crystal display device provided in the television reception device of FIG. 1, FIG. 3 shows a plan view of the chassis that houses cold cathode tubes, and FIG. 4 shows a bottom view of the chassis in a state in which inverter boards are attached.

Note that the X axis, Y axis, and Z axis are shown in some of the figures, and these axes in the respective figures indicate the same directions, respectively. Further, the upper side shown in FIG. 2 is taken as the front side (front surface side or light-emitting side), while the lower side shown in FIG. 2 is taken as the rear side (rear surface side or the side opposite to the light-emitting side).

As shown in FIG. 1, the television reception device TV according to the present embodiment includes the liquid crystal display device 10 (display device), front and back cabinets Ca and Cb that house the liquid crystal display device 10 in a sandwiching manner, a power supply P, a tuner T, and a stand S. The liquid crystal display device 10 has a horizontally elongated rectangular shape as a whole and is disposed so as to stand vertically. As shown in FIG. 2, this liquid crystal display device 10 includes a liquid crystal panel 11 as a display panel and a backlight device 12 (illumination device) as an external light source, and these members are held in a unified manner by a frame-shaped bezel 13 or the like.

Next, the liquid crystal panel 11 and the backlight device 12 that make up the liquid crystal display device 10 will be described.

The liquid crystal panel (display panel) 11 includes a pair of glass substrates that are bonded to each other through a specified gap and a liquid crystal sealed between the two glass substrates. One of the glass substrates is provided with switching elements (such as TFTs) connected to source wiring lines and gate wiring lines that are orthogonal to each other, pixel electrodes connected to these switching elements, an alignment film, and the like. The other glass substrate is provided with a color filter in which respective colored portions such as R (red), G (green), and B (blue) are disposed in a prescribed arrangement, an opposite electrode, an alignment film, and the like.

As shown in FIG. 2, the backlight device 12 includes a substantially box-shaped chassis 14 having an opening on the side of the light-emitting surface, a set of optical members 15 disposed so as to cover the opening of the chassis 14, and a frame 16 that is disposed along the peripheral edge portion of the chassis 14 and that sandwiches the outer peripheral edge portion of the set of optical members 15 with the chassis 14. The chassis 14 includes cold cathode tubes 17 constituting the light source, relay connectors 20 having a function of relaying the electrical connection at the ends of the cold cathode tubes 17, and holders 18 that collectively cover the relay connectors 20 and the ends of the cold cathode tubes 17. Inverter boards 30 (power supply boards) are disposed on the rear side of the chassis 14, and are connected to the corresponding relay connectors 20.

The chassis 14 is made of a metal such as aluminum and includes a bottom plate 14a having a rectangular shape in plan view in a manner similar to the liquid crystal panel 11. The long-side direction of this bottom plate 14a coincides with the X-axis direction in each figure, while the short-side direction coincides with the Y-axis direction in each figure. At the opposite ends in the long-side direction of the bottom plate 14a, connector insertion holes 14b into which the relay connectors 20 can be inserted are formed so as to penetrate the bottom plate 14a. The connector insertion holes 14b are arranged side by side along the Y-axis direction (the short-side direction of the bottom plate 14a) so as to correspond to the number of the relay connectors 20 connected to the ends of the cold cathode tubes 17.

The optical members 15 are formed in a rectangular shape in a plan view in a manner similar to the liquid crystal panel 11 and the bottom plate 14b of the chassis 14 by using a transparent synthetic resin, and are interposed between the cold cathode tubes 17 on the rear side and the liquid crystal panel 11 on the front side. The optical members 15 are constituted of a diffusion plate, a diffusion sheet, a lens sheet, and a brightness enhancement sheet (reflective-type polarizing sheet), for example, in this order from the rear side, and have functions such as converting light emitted from the respective cold cathode tubes 17, which are linear light sources, to uniform planar light.

The frame 16 has a frame shape along the outer peripheral edge portion of the liquid crystal panel 11 and the optical members 15. The frame 16 is disposed on the front side of the optical members 15 so as to sandwich the outer peripheral edge portion of the optical members 15 with the holders 18. Further, the frame 16 receives the rear side of the liquid crystal panel 11, thereby sandwiching the liquid crystal panel 11 with the bezel 13 that is disposed on the front side of the liquid crystal panel 11.

The cold cathode tube 17 is a linear light source (tube-form light source), and is disposed inside the chassis 14 such that the axial direction thereof coincides with the long-side direction of the chassis 14 (X-axis direction). As shown in FIG. 3, a plurality of cold cathode tubes 17 are arranged along the short-side direction of the chassis 14 (Y-axis direction) so as to be substantially parallel with each other with a prescribed spacing therebetween.

The cold cathode tube 17, which is a discharge tube, includes an elongated glass tube 17a that has a circular cross-section and that has both ends sealed, a pair of electrodes (not illustrated) respectively sealed therein at the two ends of the glass tube 17a, and a pair of outer leads 17b respectively protruding to the outside from the two ends of the glass tube 17a. In the glass tube 17a, mercury or the like, which is a light-emitting substance (neither this nor a fluorescent material is illustrated), is sealed, and the inner wall surface thereof is coated with a fluorescent material. The outer lead 17b, which is made of a metal having electrical conductivity, has an elongated substantially cylindrical shape that protrudes outward (the direction opposite to the electrode side) from an end of the glass tube 17a along the axial direction thereof (X-axis direction), and holds the same potential as that of the electrode by having the inner end thereof connected to the electrode in the glass tube 17a.

Each of the holders 18 is made of a white synthetic resin, which has superior light reflectivity, and as shown in FIG. 2, is extended along the short-side direction of the chassis 14 so as to form a substantially box shape that is open on the rear side. By attaching a pair of holders 18 to the opposite ends in the long-side direction of the chassis 14 (X-axis direction), it is possible to collectively cover the ends (non-light-emitting portions) of the respective cold cathode tubes 17 that are disposed in the corresponding positions so as to be arranged side by side along the Y-axis direction.

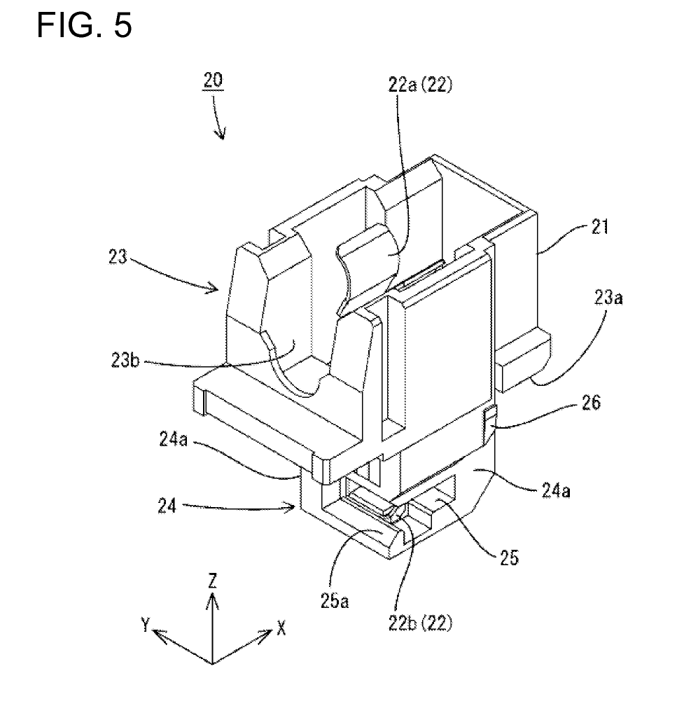

Next, the relay connectors 20 will be described using FIGS. 5 to 7.

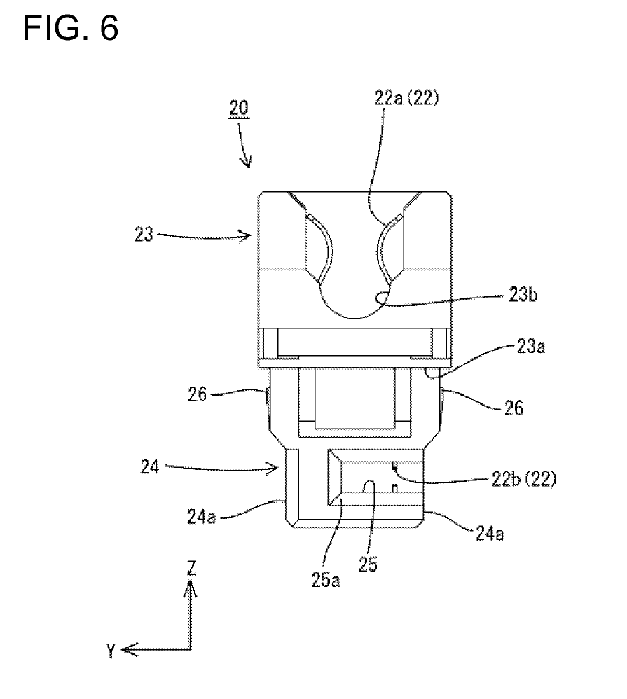

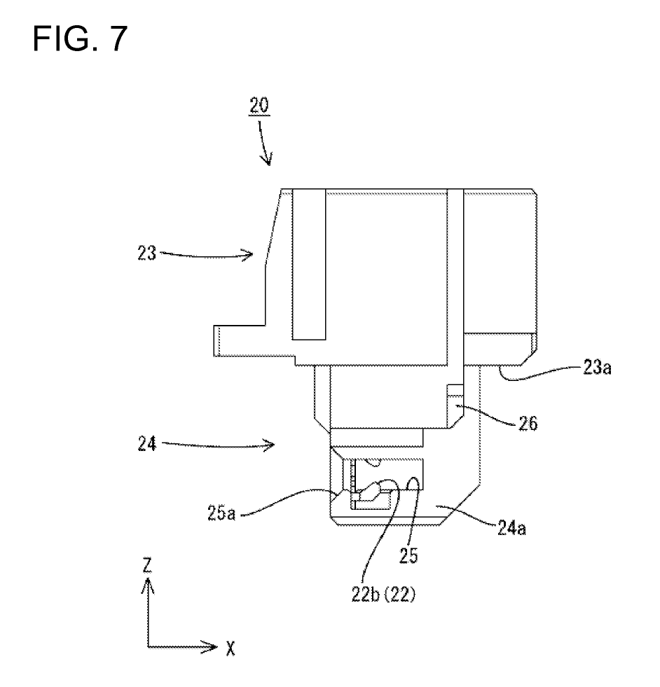

FIG. 5 shows a perspective view of a relay connector 20, FIG. 6 shows a side view of the relay connector 20 on the side to which a cold cathode tube 17 and an inverter board 30 are attached, and FIG. 7 shows a side view of the relay connector 20 on the side along the X-axis direction.

The relay connectors 20, each of which is made of two portions, are disposed on the chassis 14 at positions corresponding to the respective ends of the cold cathode tubes 17, i.e., the opposite ends in the long-side direction of the bottom plate 14a. The relay connectors are provided as many as the cold cathode tubes 17, and are arranged side by side along the short-side direction of the bottom plate 14a (Y-axis direction; the direction in which the cold cathode tubes 17 are arranged) (see FIG. 3). The array pitch of the respective relay connectors 20 is substantially equal to the array pitch of the respective cold cathode tubes 17.

As shown in FIG. 5, each of these relay connectors 20 includes a housing 21 that is made of a synthetic resin having the insulation property and that has a substantially block shape as a whole and a terminal 22 housed inside the housing 21. As shown in FIG. 6, the portion of the housing 21 that is disposed inside (on the front side of) the chassis 14 is a light source receiving unit 23 that receives the end of the cold cathode tube 17 (the outer lead 17b or a socket that is connected to the outer lead 17b and fitted over the glass tube 17a). The portion disposed outside (on the rear side of) the chassis 14 is a board housing unit 24 that houses the corresponding connector connecting portion 31 of the inverter board 30, which will be described later. The light source receiving unit 23 has a larger dimension in the X-axis direction than that of the board housing unit 24, and the boundary surface between this wider light source receiving unit 23 and the board housing unit 24 becomes an engaging surface 23a that engage the peripheral edge portion of the corresponding connector insertion hole 14b formed inside of the chassis 14 when this relay connector is attached to the chassis 14.

An arc-shaped groove portion 23b that corresponds to a shape of the end of the cold cathode tube 17 is formed in the light source receiving unit 23. The board housing unit 24 is provided with a board insertion opening 25 (corresponding to the board housing portion) that opens toward the inverter board 30 along the X-axis direction and that opens toward a side that becomes the lower side of the liquid crystal display device 10 shown in FIG. 7 along the Y-axis direction. As shown in FIG. 7, an inviting portion 25a (inviting surface) that is inclined inward is formed in the board insertion opening 25 at the edge portion on the side facing the inverter board 30. The side surfaces (side walls) of the board housing unit 24 along the X-axis direction become guide surfaces 24a that make contact with the corresponding contact portions 34 (connector contact portions) of the inverter board 30, which will be described later. Moreover, a pair of elastic stoppers 26 that extend in a cantilever fashion in the same direction as the direction in which the relay connector 20 is attached to the chassis 14 are formed on the side portions of the board housing unit 24 on the same sides as the guide surfaces 24a. The relay connector 20 can be affixed to the chassis 14 by inserting the relay connector 20 through the connector insertion hole 14c in the chassis 14 and sandwiching the chassis 14 between the engaging surface 23a and the elastic stoppers 26.

The terminal 22 housed inside the housing 21 include light source-side connecting portions 22a disposed inside the light source receiving unit 23 and board-side connecting portions 22b disposed inside the board housing unit 24. The light source-side connecting portions 22a are made of a pair of elastic clamping pieces, which hold the cold cathode tube 17 while establishing an electrical connection by making contact with the outer lead 17b (or the socket that is connected to the outer lead 17b and fitted over the glass tube 17a) of the cold cathode tube 17. The board-side connecting portions 22b are formed of a pair of elastic pieces that protrude toward the interior of the board insertion opening 25 in a direction along the Z-axis direction, and clamp the corresponding connector connecting portion 31 including the terminal 32, while establishing an electrical connection by making contact with the corresponding terminal 32 of the inverter board 30, which will be described later. The output voltage that is output from the inverter board 30 is relayed by these relay connectors 20, and is input into the electrodes through the outer leads 17b of the cold cathode tubes 17.

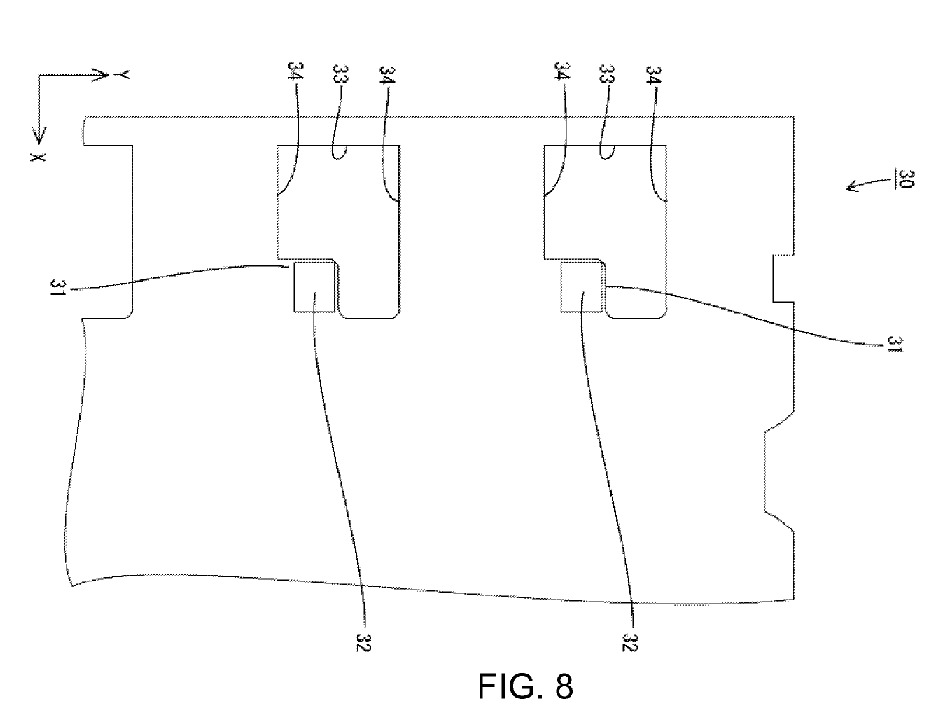

Next, the inverter board 30 will be described using FIGS. 2, 4, and 8. FIG. 8 is an enlarged plan view of the inverter board 30.

The inverter board 30 is formed by forming a prescribed wiring pattern on a base material made of a synthetic resin (such as a glass cloth base material made of epoxy resin or made of paper phenol) and by mounting various electronic components thereon. Specifically, as shown in FIG. 2, a lead component 30a such as a transformer or a capacitor is mounted on the rear surface (the surface on the side opposite to the chassis 14) of the inverter board 30, and on the front surface (the surface on the side of the chassis 14), a wiring pattern (not illustrated) is formed, and chip components 30b such as a resistor, a diode, and a capacitor are mounted. Of these components, the leads of the lead component 30a are soldered to the wiring pattern such that these leads pass through through-holes in the inverter board 30 and protrude to the front surface. The chip components 30b are surface-mounted on the wiring pattern on the front surface of the inverter board 30. These inverter boards 30 are connected to the power supply P of the liquid crystal display device 10 and have the function of turning on and off the cold cathode tubes 17 by boosting an input voltage from this power supply P and by outputting to the cold cathode tubes 17 the output voltage that is higher than the input voltage. Note that in the inverter boards 30 in figures other than FIG. 2, the lead component 30a and the chip components 30b are not shown.

As shown in FIG. 4, the inverter boards 30 are attached to the rear surface (the surface on the side opposite to the cold cathode tubes 17) of the bottom plate 14a of the chassis 14 such that a pair of the inverter boards 30 are disposed at the respective end positions in the long-side direction (X-axis direction) of the bottom plate 14a in a symmetrical manner. Each inverter board 30 has a substantially rectangular shape in a plan view, and is disposed such that the surface thereof is substantially parallel with the surface of the bottom plate 14a of the chassis 14, and such that the long-side direction thereof coincides with the direction in which the relay connectors 20 are aligned (Y-axis direction or short-side direction of the bottom plate 14a). The inverter boards 30 are affixed to the bottom plate 14a in this manner by metal screws or the like.

As shown in FIG. 8, the connector connecting portions 31 that are to be inserted into and held by the corresponding relay connectors 20 are provided in the side portion of each inverter board 30 on the side close to the relay connectors 20. The connector connecting portions 31 have a substantially square shape that matches the shape of the board insertion openings 25 of the respective relay connectors 20, and a plurality of these connector connecting portions 31 are disposed so as to be aligned in the long-side direction of each inverter board 30 (Y-axis direction). The terminals 32 that are extended from the wiring pattern and that can be electrically connected, from both the front and back surfaces thereof, to the terminal 22 of the corresponding relay connectors 20 are respectively provided in the substantially central positions of the connector connecting portions 31.

Holding holes 33 (holes) that form the outer shapes of the respective connector connecting portions 31 and that allow the relay connectors 20 to be inserted through, respectively, are formed in each inverter board 30 in areas that are closer to the relay connectors 20 than the connector connecting portions 31. Specifically, one holding hole 33 is provided for each of the connector connecting portions 31 so as to correspond to the number of the relay connectors 20. Of the inner peripheral edge portions of each holding hole 33, the edge portions along the X-axis direction are the contact portions 34 (connector contact portions). The dimension in the X-axis direction of each holding hole 33 is larger than the dimension in the X-axis direction of each relay connector 20, and the dimension in the Y-axis direction of each holding hole 33 substantially coincides with the dimension in the Y-axis direction of each relay connector 20. Note that each connector connecting portion 31 protrudes in an angular manner toward the inside of the corresponding holding hole 33, and therefore, an inner section of the holding hole 33 is shaped like the letter L. When the individual relay connectors 20 are inserted through the corresponding holding holes 33 of the inverter board 30, the contact portions 34 respectively make contact with the guide surfaces 24a on the two side walls of the respective relay connectors 20 along the X-axis direction and Y-axis direction. Each inverter board 30 can move, while maintaining this contact state, along the X-axis direction to the position at which the connector connecting portion 31 is inserted into the board insertion opening 25 of the corresponding relay connector 20 so as to be held therein. Then, the connector connecting portions 31 are inserted into these board insertion openings 25, and the terminals 32 and the terminals 22 of the relay connectors 20 are connected, thereby holding the inverter board 30 at a proper position and establishing the electrical connection therebetween.

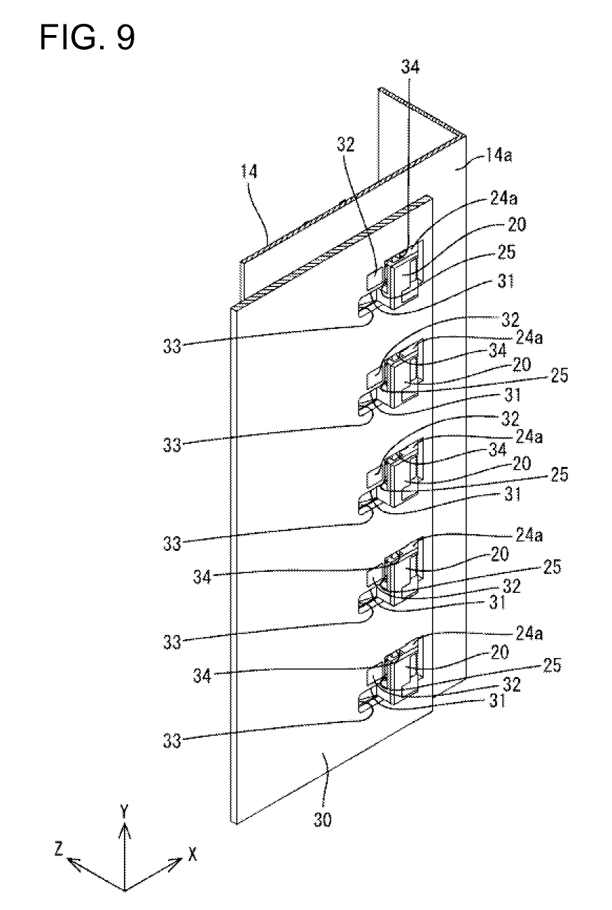

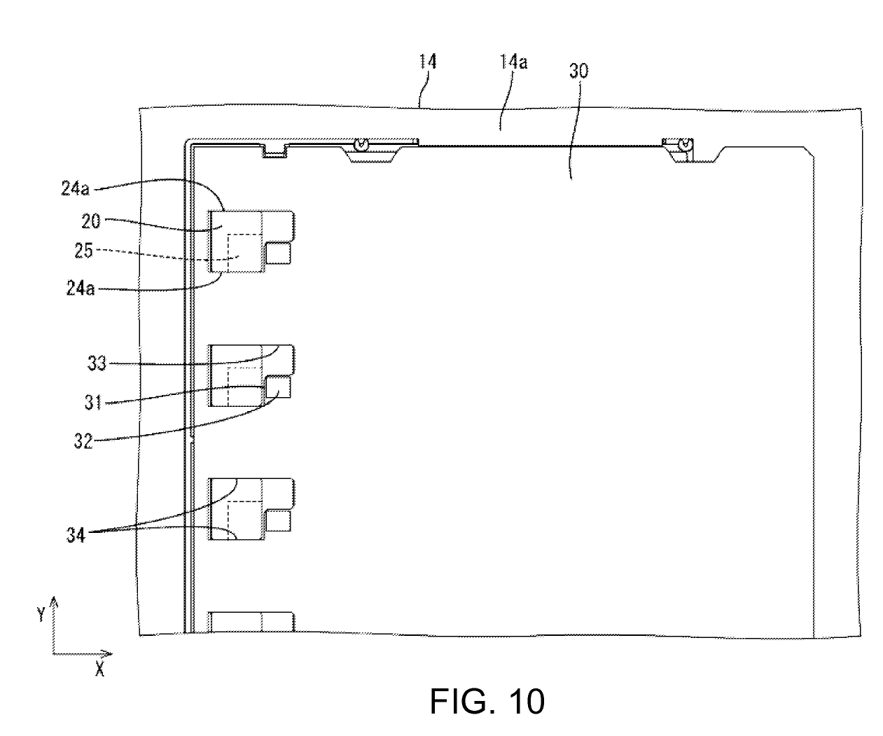

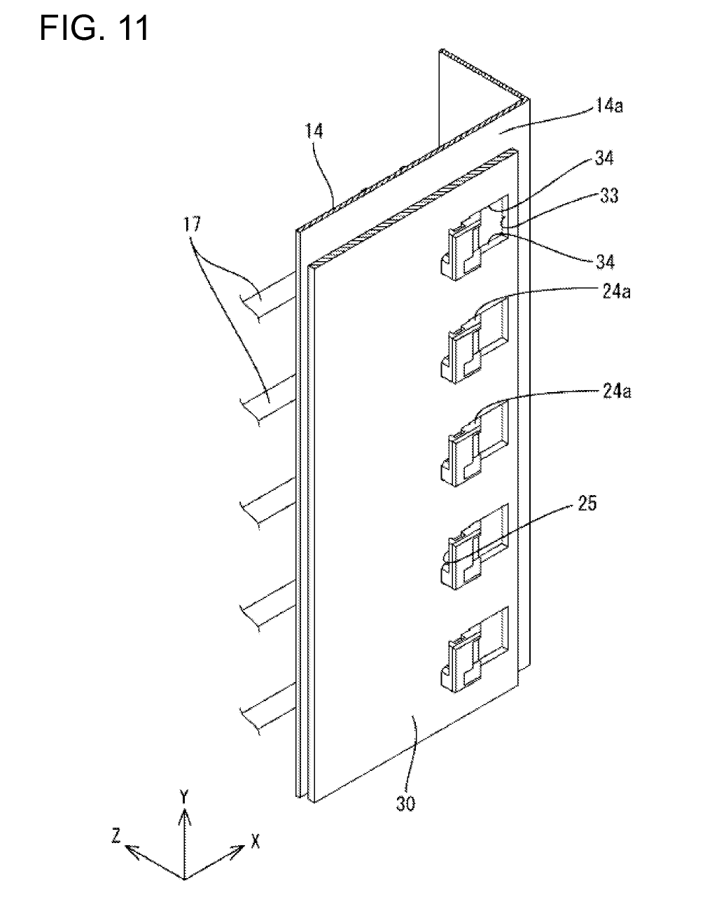

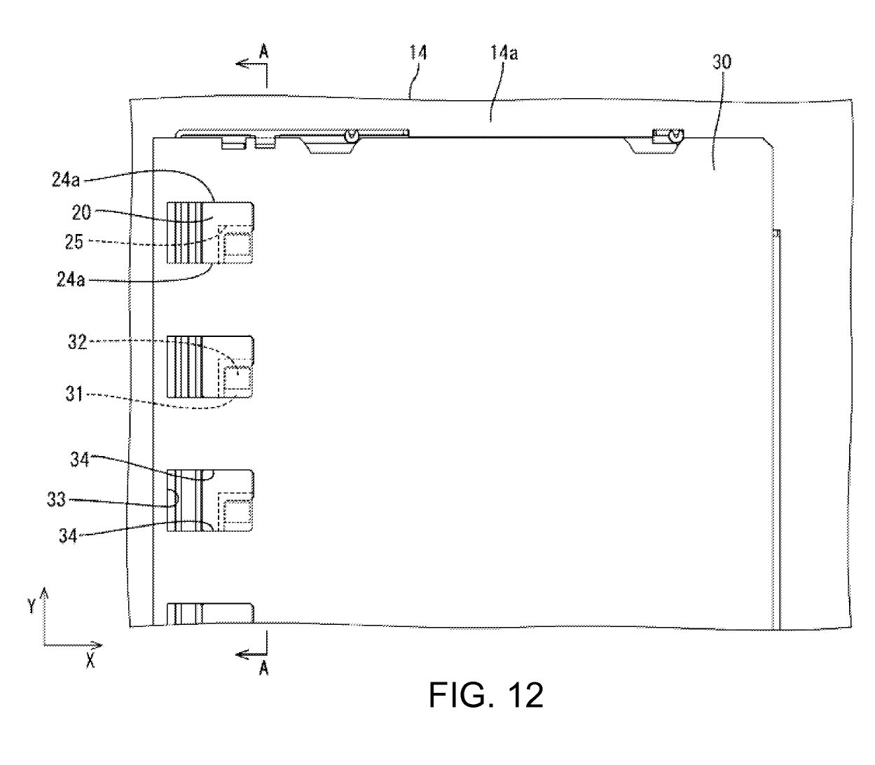

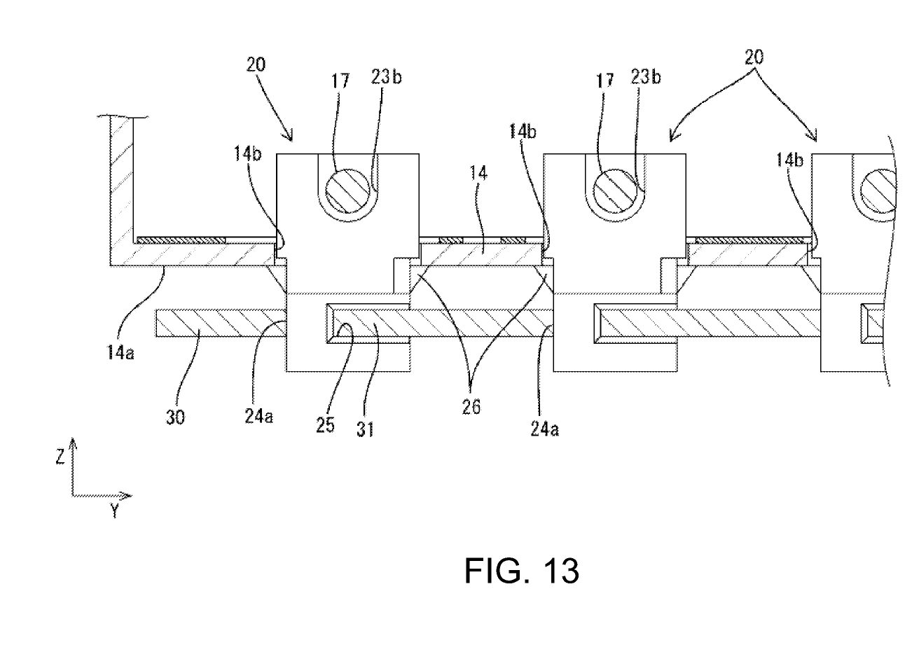

The configuration of the present embodiment has been described above. Next, the operation thereof will be described using FIGS. 2 and 9 to 13. FIG. 9 shows a partial perspective view showing the relay connectors 20 attached to the chassis 14 being inserted through the holding holes 33 of an inverter board 30, FIG. 10 shows an enlarged plan view in the same state as in FIG. 9, FIG. 11 shows a partial perspective view showing the inverter board 30 being held by the relay connectors 20 attached to the chassis 14, FIG. 12 shows an enlarged plan view in the same state as in FIG. 11, and FIG. 13 shows a sectional view along A-A in FIG. 12.

The liquid crystal display device 10 having the aforementioned configuration is manufactured by assembling the separately manufactured liquid crystal panel 11 and backlight device 12 with the bezel 13 or the like. Of these, a process of assembling the backlight device 12 will be described below.

First, as shown in FIGS. 2 and 13, the respective relay connectors 20 are attached to the chassis 14 from the inside (the front side) thereof such that the relay connectors 20 are affixed to the chassis 14. Specifically, the relay connectors 20 are respectively inserted through the connector insertion holes 14b such that the board housing units 24 of the relay connectors 20 are disposed outside (rear side) of the chassis 14. Once the elastic stoppers 26 pass through the connector insertions holes 14b, the elastic stoppers 26 elastically return, thereby engaging the peripheral edge portions of the connector insertion holes 14b on the rear side. At the same time, the engaging surfaces 23a of the relay connectors 20 respectively make contact with the peripheral edge portions of the connector insertion holes 14b on the front side. This way, the relay connectors 20 are affixed to the chassis 14.

Next, the respective cold cathode tubes 17 are housed inside the chassis 14. The cold cathode tubes 17 are attached by inserting the outer leads 17b at the ends thereof into the interior of the light source receiving units 23 of the relay connectors 20, respectively, so as to be elastically clamped by the light source-side connecting portions 22a of the terminals 22. Thereafter, the holders 18, the optical members 15, and the frame 16 are assembled to the chassis 14 in this order from the front side (see FIG. 2).

On the rear side of the chassis 14, the inverter boards 30 are attached to the chassis 14. When the inverter boards 30 are respectively placed such that the surfaces thereof on the side where the chip components 30b are disposed face the front side, and such that the respective relay connectors 20 are inserted through the corresponding holding holes 33 as shown in FIGS. 9 and 10, the contact portions 34 of the respective holding holes 33 make contact with the guide surfaces 24a of the relay connectors 20. In this state, the inverter board 30 can move only in a direction along the X-axis direction, which is the direction in which the respective connector connecting portions 31 are inserted into the board insertion openings 25 of the corresponding relay connectors 20 (not movable in the Y-axis direction).

Next, the connector connecting portions 31 of the inverter boards 30 are inserted into the board insertion openings 25 of the corresponding relay connectors 20, respectively. That is, the inverter boards 30 are caused to slide toward the board insertion openings 25.

Then, as a result of the contact portions 34 being respectively guided by the guide surfaces 24a of the relay connectors 20, the connector connecting portions 31 of the inverter boards 30 are inserted into the board insertion openings 25 without causing a misalignment in the Y-axis direction that intersects with the X-axis direction, which is the insertion direction (see FIGS. 11, 12, and 13). In the inserted connector connecting portions 31, the board-side connecting portions 22b in the board insertion openings 25 elastically make contact with the corresponding terminals 32, thereby establishing the electrical connection, and the inverter boards 30 are held by the relay connectors 20. Subsequently, the inverter boards 30 that are held by the relay connectors 20, respectively, are affixed to the chassis 14 by screws or the like, which are not illustrated.

As described above, the backlight device 12 of the present embodiment includes the plurality of cold cathode tubes 17, the chassis 14 that houses the cold cathode tubes 17, the inverter boards 30 that are disposed on the chassis 14 on the side opposite to the cold cathode tubes 17 and that supply driving power to the cold cathode tubes 17, and the plurality of relay connectors 20 that are attached to the chassis 14 and that relay the supply of power from the inverter boards 30 to the plurality of the cold cathode tubes 17. Furthermore, the inverter boards 30 can be inserted into and removed from the relay connectors 20 in a direction along the plane of the inverter boards 30, and respectively include the terminals 32 that are electrically connected to the relay connectors 20 on the front end in the insertion direction into the relay connectors 20 and the contact portions 34 that make contact with, preceding to the terminals 32, the side walls of the relay connectors 20 along the insertion direction of the inverter boards 30 so as to guide the insertion of the terminals 32 into the relay connectors 20 when the inverter boards 30 are inserted into the relay connectors 20.

With such a configuration, when the inverter board 30 is inserted into the relay connectors 20 so that power is supplied from the inverter board 30 to the cold cathode tubes 17 via the corresponding relay connectors 20, preceding to the terminals 32 provided on the inverter board 30, the contact portions 34 make contact with the side walls of the corresponding relay connectors 20 along the insertion direction of the inverter board 30, and this contact makes it possible to guide the inverter board 30 to the insertion direction into the relay connectors 20. Consequently, the inverter board 30 cannot move in other directions along the plane of the board than the insertion direction, thereby preventing damage to the inverter board 30 and the relay connectors 20 caused by a misaligned inverter board 30 being inserted in the interior of the relay connectors 20.

The relay of power, which is the principal function of the relay connectors 20, is achieved by the electrical connection between the terminals 32 of the inverter board 30 and the terminals 22 inside the corresponding relay connectors 20, and therefore, it is understood that preventing damage to the terminals 32 of the inverter board 30 is the most important object. Thus, in the present embodiment, the inverter board 30 is provided with the contact portions 34 on the front side of the terminals 32 in the direction in which the inverter board 30 is inserted into the relay connectors 20 such that the insertion of the inverter board 30 is guided by the contact portions 34. This prevents or suppresses the movement of the inverter board 30 in directions different from the insertion direction, thereby suppressing the occurrence of the problem of the terminals 32 and the terminals 22 of the relay connectors 20 making unintended contacts with each other and getting damaged.

In the present embodiment, the contact portions 34 are constituted of the inner edge portions of the holding holes 33 that have been formed by punching the inverter board 30, and by having the relay connectors 20 inserted through the corresponding holding holes 33, the inverter board 30 and the relay connectors 20 are properly positioned in a direction intersecting with the insertion direction. With such a configuration, by inserting the relay connectors 20 through the holding holes 33 that constitute the contact portions 34 first, an approximate alignment of the inverter board 30 to the relay connectors 20 can be performed. That is, the position of the inverter board 30 in the direction that intersects with the insertion direction can be determined before it is held by the relay connectors 20. Thus, it is possible to more reliably prevent the inverter board 30 from being inserted into the relay connectors 20 in an inclined manner relative to the normal insertion direction.

Further, by using the inner edge portions of the punched holding holes 33 as the contact portions 34, the strength of the contact portions 34 can be increased. Moreover, because the contact portions 34 are constituted of the inner edge portions of the holding holes 33, unlike the case where protruding pieces that protrude beyond the end portion of the inverter board 30 are used as the contact portions 34, there is no need to add sharp angular portions, which allows for the better handling during work.

In addition, in the present embodiment, the contact portions 34 are provided respectively for the corresponding relay connectors 20. By providing one pair of contact portions 34 for each of the relay connectors 20, it becomes possible to improve the accuracy in guiding the inverter board 30 to the insertion direction into the relay connectors 20, and as a result, the inverter board 30 can be attached to the relay connectors 20 more accurately. Furthermore, when the inner edge portions of the plurality of holding holes 33 that correspond to the number of the relay connectors 20 are used as the contact portions 34, a portion to be punched out to form the holding holes 33 can be divided into smaller segments, and therefore, the strength of the contact portions 34 is increased.

Moreover, the contact portions 34 of the present embodiment are formed in a portion of the inverter board 30 that is extended to the front side beyond the terminals 32 in the direction in which the inverter board 30 is inserted into the relay connectors 20. When the contact portions 34 are formed in the portion of the inverter board 30 that is extended beyond the terminals 32 in the direction in which the inverter board 30 is inserted into the relay connectors 20, a larger board thickness can be ensured around the terminals 32, thus increasing the strength of the terminals 32.

Each of the relay connectors 20 in the present embodiment includes a board insertion opening 25 that can house the inverter board 30 therein. The board insertion opening 25 is open in one of the two directions orthogonal to the direction in which the inverter board 30 is inserted into the relay connector 20 on the plane of the inverter board 30, and is closed in at least the other one of such two directions and on a side facing the chassis 14. In the board insertion opening, a pair of the board-side connecting portions 22b that can establish an electrical connection while elastically clamping the terminal 32 are formed at positions that respectively face the terminal 32 when the inverter board 30 and the relay connector 20 engage each other. These relay connectors 20 are plurally disposed so as to be aligned along at least one side of the chassis 14, and the openings of the board insertion openings 25 of the respective relay connectors 20 are facing in the same direction.

In the backlight device 12 having the relay connectors 20 configured in this manner, the inverter boards 30 to be inserted into the relay connectors 20 may move in a direction in which the openings of the board insertion openings 25 of the relay connectors 20 are facing, and therefore, the inverter board 30 is more likely to be misaligned to the relay connectors 20 when the inverter board 30 is inserted into the corresponding relay connectors 20. To solve the problem in such relay connectors 20, the contact portions 34 are provided in the inverter board 30 of the present embodiment so as to prevent the inverter board 30 from moving in other directions than the insertion direction along the plane of the board. Therefore, in the backlight device 12 having such relay connectors 20, the contact portions 34 provided in the inverter board 30 can be used more effectively to prevent a misalignment in directions other than the insertion direction thereof.

Moreover, in each board insertion opening 25, an inviting portion 25a having an inclination that guides the inverter board 30 into the interior of the board insertion opening 25 is formed on the inside of an edge of the opening on the side from which the inverter board 30 is inserted. This makes it easier to insert the inverter board 30 into the board insertion openings 25, thereby improving work efficiency.

### Embodiment 2

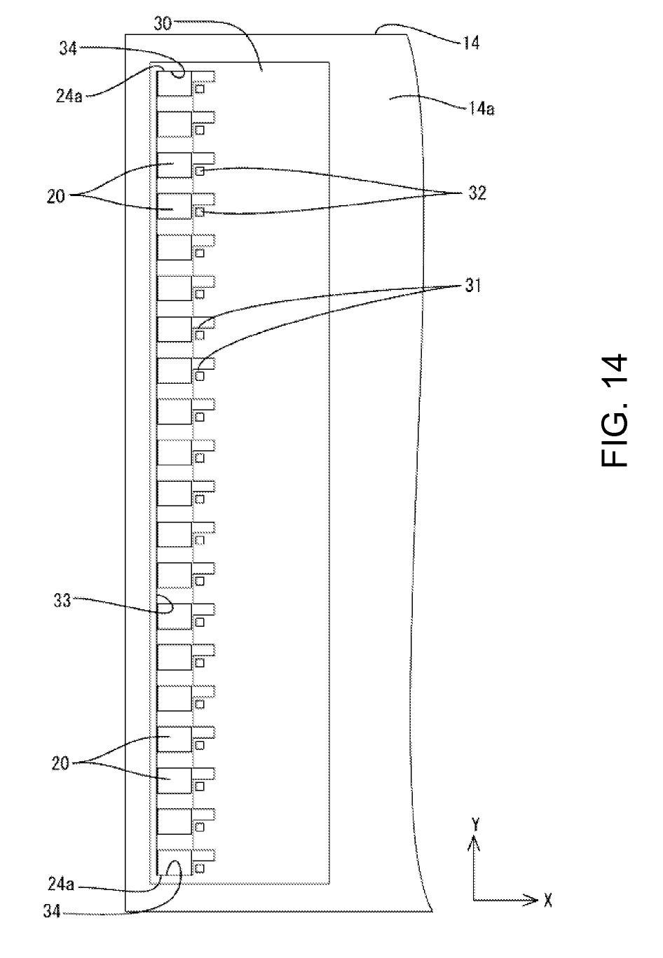

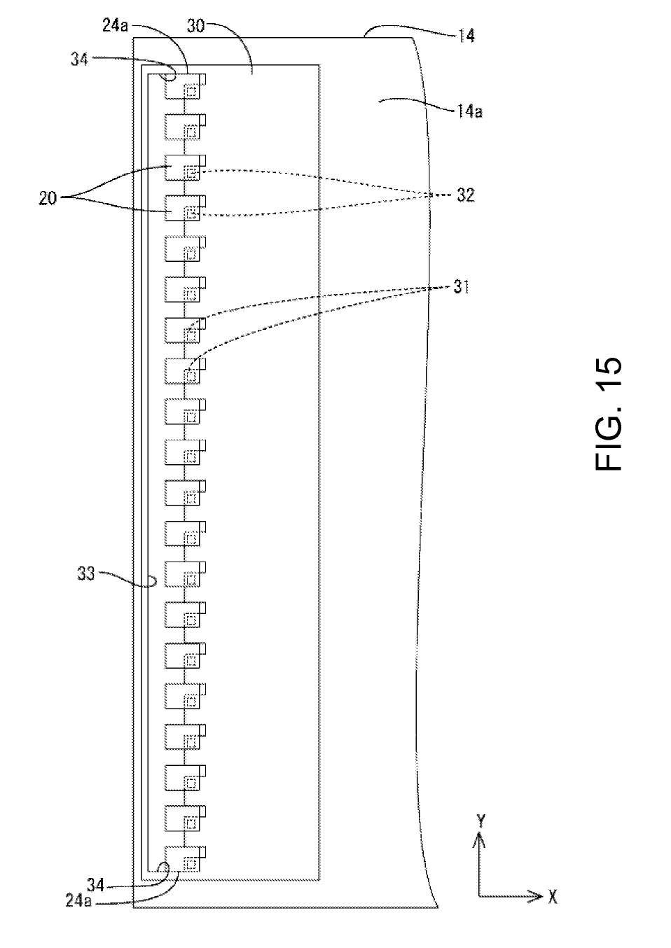

Next, Embodiment 2 of the present invention will be described based on FIGS. 14 and 15.

The present embodiment differs from Embodiment 1 in the configuration of the holding holes 33 and hence the arrangement and number of the contact portions 34. The other configurations are the same as those of Embodiment 1, and therefore, descriptions thereof are omitted. FIG. 14 is a partial plan view showing the relay connectors 20 attached to the chassis 14 being inserted through the holding hole 33 in the inverter board 30, and FIG. 15 is a partial plan view showing the inverter board 30 being held by the relay connectors 20 attached to the chassis 14.

As shown in FIG. 14, each inverter board 30 has one holding hole 33 that forms the outer shape of the respective connector connecting portions 31 and that allows all of the relay connectors 20 located at the same position in the X-axis direction on the chassis 14 to pass through. In the inverter board 30, the holding hole 33 is located closer to the relay connectors 20 than the connector connecting portions 31. Of the inner peripheral edge portions of the holding hole 33, the edge portions along the X-axis direction become the contact portions 34. The dimension in the X-axis direction of the holding hole 33 is larger than the dimension in the X-axis direction of the relay connectors 20, and the dimension in the Y-axis direction of the holding hole 33 substantially coincides with the distance between respective outer side walls of the two relay connectors 20 located at the opposite ends in the Y-axis direction of the chassis 14. Specifically, the respective outer side walls of the relay connectors 20 located at the opposite ends in the Y-axis direction of the chassis 14 serve as the guide surfaces 24a, and by the pair of contact portions 34, which are the inner peripheral edge portions of the holding hole 33 along the X-axis direction, making contact with the pair of guide surfaces 24a, respectively, the inverter board 30 is guided to the insertion direction into the relay connectors 20. Note that each of the connector connecting portions 31 is formed so as to protrude toward the inside of the holding hole 33.

When the relay connectors 20 are inserted through the inverter board 30, the contact portions 34 of the inverter board 30 make contact with the guide surfaces 24a on the outer side of the two relay connectors 20 located at the opposite ends in the Y-axis direction of the chassis 14 as shown in FIG. 14. By the contact portions 34 being guided by the guide surfaces 24a of the relay connectors 20, the connector connecting portions 31 of the inverter board 30 are inserted into the board insertion openings 25 along the X-axis direction, which is the insertion direction, without causing a misalignment (see FIG. 15).

As described above, with the configuration of the present embodiment, effects similar to those of Embodiment 1 can be obtained, and in addition, by having one holding hole 33 for each inverter board 30, the forming process can be simplified as compared with Embodiment 1 in which one holding hole 33 is provided for every relay connector 20. Furthermore, by reducing the number of the contact portions 34 to a single pair, the number of locations that require accuracy control such as geometric tolerances so as to ensure the proper contact with the guide surfaces 24a of the relay connectors 20 can be reduced as compared with Embodiment 1, which results in the lower defect ratio and thus the higher production efficiency.

### Embodiment 3

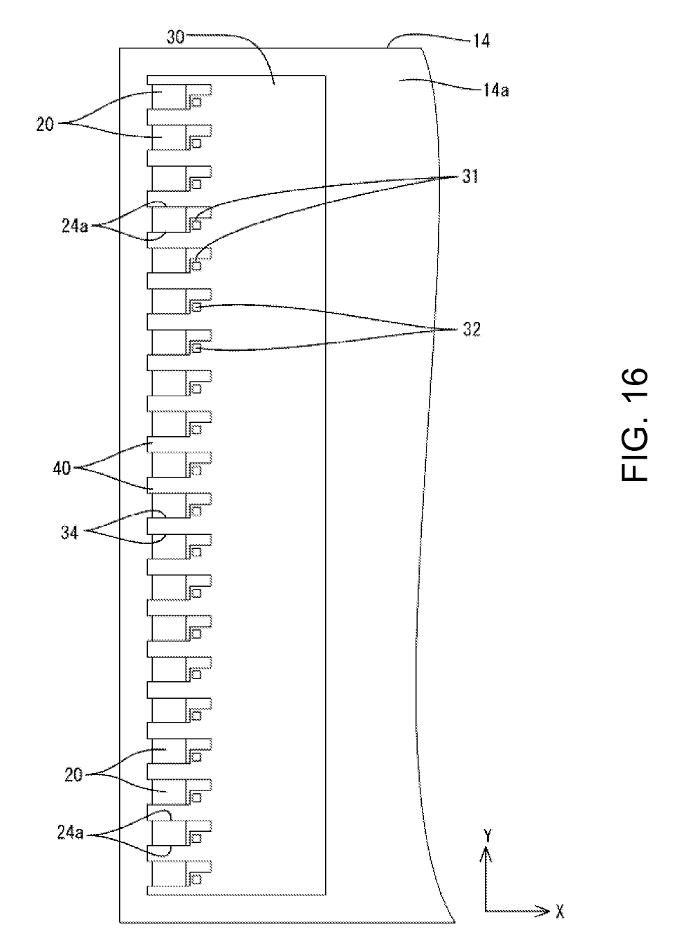

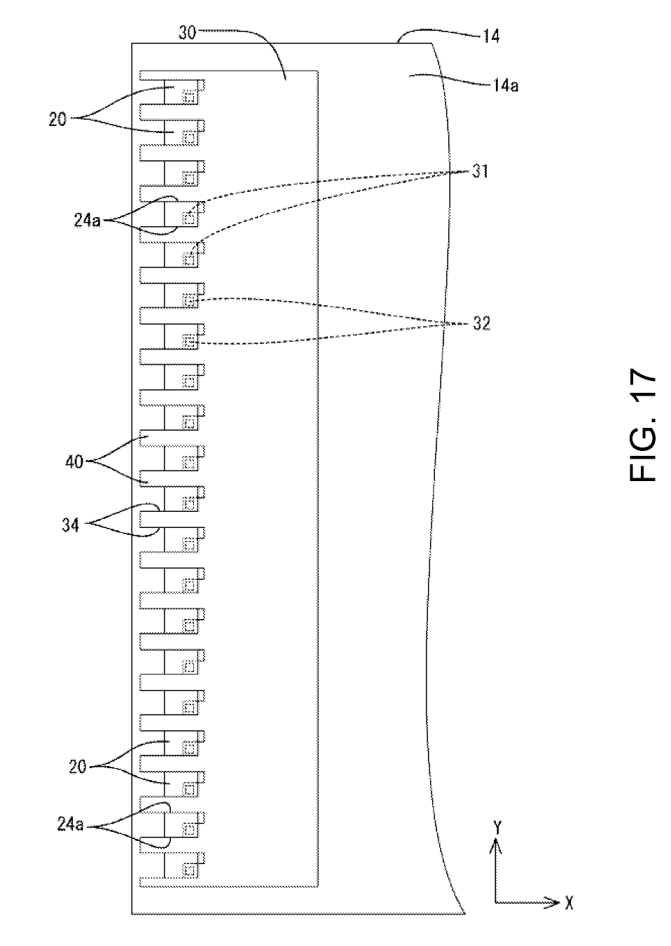

Next, Embodiment 3 of the present invention will be described based on FIGS. 16 and 17.

The present invention differs from Embodiments 1 and 2 in the structure of the contact portions 34. The other configurations are the same as those of Embodiment 1, and therefore, descriptions thereof are omitted. FIG. 16 shows a partial plan view immediately before the connector connecting portions 31 of the inverter board 30 are inserted into the corresponding relay connectors 20 attached to the chassis 14, and FIG. 17 shows a partial plan view of the inverter board 30 being held by the relay connectors 20 attached to the chassis 14.

In the inverter board 30, protruding portions 40 that extend along the X-axis direction beyond the connector connecting portions 31 of the inverter board 30 toward the side of the relay connectors 20 are formed. One protruding portion 40 is provided for each of the connector connecting portions 31, and the width dimension thereof substantially coincides with the spacing between the respective relay connectors 20 in the Y-axis direction such that the protruding portion 40 can make contact with the side walls along the X-axis direction of the respective relay connectors 20. Specifically, the protruding portions 40 are disposed so as to fill the gaps between the respective relay connectors 20 in the Y-axis direction when the connector contact portions 31 of the inverter board 30 are inserted into the board insertion openings 25 of the relay connectors 20. Two side portions of the protruding portions 40 that can make contact with the side walls of these relay connectors 20 are the contact portions 34. The side walls of the relay connectors 20 that make contact with the contact portions 34 are the guide surfaces 24a.

The protruding length of the protruding portions 40 is larger than the dimension of each relay connector 20 on the side of the guide surfaces 24a, and in a state immediately before the connector connecting portions 31 of the inverter board 30 are inserted into the board insertion openings 25 of the relay connectors 20, the protruding portions 40 are protruding from the relay connectors 20 toward the outer periphery of the chassis 14. That is, prior to the insertion of the connector connecting portions 31 into the board insertion openings 25, the contact portions 34 are in contact with the entire guide surfaces 24a in the X-axis direction, thereby preventing the inverter board 30 from moving in other directions than the X-axis direction.

In order to attach such inverter board 30 to the relay connectors 20, the inverter board 30 is caused to slide in the X-axis direction, which is the insertion direction, such that the corresponding protruding portions 40 are inserted into the gaps between the relay connectors 20 in the Y-axis direction. That is, by the contact portions 34, which are the side portions of the protruding portions 40, making contact with the guide surfaces 24a, which are the respective two side portions of all the relay connectors 20, the connector connecting portions 31 of the inverter board 30 can be inserted into the board insertion openings 25 without being misaligned to the relay connectors 20.

As described above, the contact portions 34 of the present embodiment are constituted of the plurality of protruding portions 40 that protrude in the direction in which the inverter board 30 is inserted into the corresponding relay connectors 20. By using the plurality of protruding portions 40 as the contact portions 34, the extending length of the protruding portions 40 can be selected freely as compared with Embodiments 1 and 2 where the contact portions 34 were formed by utilizing the inner peripheral edge portions of the holding holes 33. Specifically, when the contact portions 34 are the inner peripheral edge portions of the holding holes 33, these holding holes 33 must be large enough to allow the insertion of the relay connectors 20. In contrast, when the contact portions 34 are the protruding portions 40, the inverter board 30 can be inserted into the corresponding relay connectors 20 without having the relay connectors 20 inserted therethrough. Therefore, by using the protruding portions 40 that are shorter than the dimension of the side walls of the relay connectors 20 along the insertion direction of the inverter board 30 as the contact portions 34, for example, the inverter board 30 can be reduced in size, and the material cost can therefore be reduced.

### Other Embodiments

The present invention is not limited to the embodiments described based on the aforementioned descriptions and figures, and the following embodiments are also included in the technical scope of the present invention, for example.

(1) In each of the aforementioned embodiments, the relay connectors 20 were aligned along the short-side direction (Y-axis direction) with equal spacing therebetween at the opposite ends of the long-side direction (X-axis direction) of the chassis 14. However, the present invention is not limited to this; the positions of the respective relay connectors 20 in the X-axis direction may be different, and it is not absolutely necessary that the spacing between the relay connectors 20 in the Y-axis direction be constant as long as the relay connectors 20 are disposed such that the power from the inverter boards 30 can be supplied to the respective cold cathode tubes 17. Thus, the contact portions 34 of each inverter board 30 do not have to be formed at equal intervals, and may be formed in other manners as long as they can make contact with the respective guide surfaces 24a of the corresponding relay connectors 20.

(2) In each of the aforementioned embodiments, the board-side connecting portions 22b of the terminal 22, which are provided in the board insertion opening 25 of each relay connector 20, were made of a pair of elastic pieces that clamp the inverter board in the Z-axis direction, but the board-side connecting portions 22b are not limited to this and may also have a structure such that a board-side connecting portion 22b makes contact with the terminal 32 formed on one surface of the inverter board 30, and sandwiches the inverter board 30 with an inside surface of the board insertion opening 25. In this case, the terminal 32 may be formed only on one surface on the side that makes contact with the board-side connecting portion 22b of the terminal 22.

(3) In Embodiment 1 described above, one holding hole 33 is provided for each of the relay connectors 20, but the holding holes 33 are not limited to this, and the relay connectors 20 that are on the same side in the X-axis direction may be inserted through one holding hole collectively as in Embodiment 2, or the relay connectors 20 that are on the same side in the X-axis direction may be divided into two groups and inserted through two holding holes 33, for example. Alternatively, it can be configured such that only one relay connector 20 out of the relay connectors 20 corresponding to one inverter board 30 is inserted through the holding hole 33, or such that relay connectors 20 that are selected from a plurality of relay connectors 20 are inserted through a plurality of holding holes 33, respectively. However, the dimensions of the holding holes need to be designed such that all of the contact portions 34, which are the inner peripheral edge portions of the respective holding holes 33 along the insertion direction, can simultaneously make contact with the respective guide surfaces 24a of the corresponding relay connectors 20.

(4) In Embodiment 3 described above, the protruding portions 40 were configured so as to extend in the insertion direction from the end portions of all the connector connecting portions 31 toward the relay connectors 20, but the protruding portions 40 are not limited to this; it is also possible to form a single protruding portion 40 that can be inserted in a gap between two adjacent relay connectors 20, for example. Even when the plurality of protruding portions 40 are not formed, when the contact portions 34, which are the two side portions of the protruding portion 40, make contact with the guide surfaces 24a, which are the side walls of the two relay connectors 20 that are affixed to the chassis 14 and that face each other along the insertion direction of the inverter board 30, the inverter board 30 can be prevented from moving in other directions than the insertion direction.

(5) In each of the aforementioned embodiments, an example where a pair of inverter boards 30 are disposed so as to correspond to the respective electrodes at both ends of the cold cathode tubes 17 was described, but the present invention is not limited to this, and it is possible to adopt a configuration in which one of the inverter boards 30 is omitted, and the cold cathode tubes 17 are driven from one side, for example. In this case, a ground circuit may be connected to the relay connectors 20 on the side not having the inverter board 30 (low voltage side).

(6) In each of the aforementioned embodiments, the cold cathode tubes 17, which are a type of fluorescent tubes, were used as an example of the light source, but the light source is not limited to this, and fluorescent tubes of other types such as hot cathode tubes may also be used. Moreover, devices using discharge tubes other than fluorescent tubes (such as mercury lamps) are also included in the present invention.

(7) In addition to the aforementioned embodiments, the screen size, the aspect ratio, and the like of the liquid crystal display device 10 can be modified as appropriate.

(8) In each of the aforementioned embodiments, a device that is disposed vertically such that the short-side direction of the liquid crystal panel 11 and the chassis 14 coincides with the vertical direction was described as an example, but the present invention is not limited to this. It is also possible to use a device that is vertically placed such that the long-side direction of the liquid crystal panel 11 and the chassis 14 coincides with the vertical direction.

(9) In each of the aforementioned embodiments, TFTs were used as the switching elements of the liquid crystal display device 10, but the present invention is not limited to this and can also be applied to a liquid crystal display device using other switching elements than TFTs (such as thin-film diodes (TFDs)), for example, and can also be applied to a black and white liquid crystal display device instead of a color liquid crystal display device.

(10) In each of the aforementioned embodiments, a liquid crystal display device using the liquid crystal panel 11 as the display panel was presented as an example, but the present invention is not limited to this and can also be applied to display devices using other types of display panel.

(11) In each of the aforementioned embodiments, a television reception device including a tuner was presented as an example, but the present invention is not limited to this and can also be applied to a display device that is not equipped with a tuner.

### DESCRIPTION OF REFERENCE CHARACTERS

10 liquid crystal display device (display device)
11 liquid crystal panel (display panel)
12 backlight device (illumination device)
14 chassis
17 cold cathode tube (light source)
20 relay connector
22 terminal
22b board-side connecting portion
24 board housing unit
24a guide surface
25 board insertion opening
30 inverter board (power supply board)
31 connector connecting portion
32 terminal
33 holding hole (hole)
34 contact portion (connector contact portion)
40 protruding portion
21 relay connector
TV television reception device

1. An illumination device comprising:
a light source;
a chassis that houses said light source;
a power supply board that is disposed on said chassis on a side opposite to said light source and that supplies driving power to said light source; and
relay connectors that are attached to said chassis and that relay a supply of power from said power supply board to said light source,
wherein said power supply board can be inserted into and removed from said relay connectors in a direction along a plane of said board, and includes terminals, which are to be electrically connected to respective said relay connectors, on a front end of said power supply board and connector contact portions that make contact with, preceding to said terminals, side walls of the respective said relay connectors along the insertion direction of said power supply board so as to guide the insertion of said terminals into said relay connectors when the power supply board is inserted into said relay connectors.

2. The illumination device according to claim 1, wherein said connector contact portions are respectively constituted of inner edge portions of holes formed by punching said power supply board, and
wherein a position of said power supply board relative to said relay connectors in a direction intersecting with the insertion direction by inserting said relay connectors through said holes, respectively.

3. The illumination device according to claim 1, wherein said connector contact portions are constituted of a plurality of protruding portions that protrude in a direction in which said power supply board is inserted into said relay connectors.

4. The illumination device according to claim 1, wherein said connector contact portions are provided so as to correspond to said relay connectors, respectively.

5. The illumination device according to claim 1, wherein said connector contact portions are constituted of a portion of said power supply board that is extended beyond the front end side of said terminals in a direction in which said board is inserted into said relay connectors.

6. The illumination device according to claim 1, wherein each of said relay connectors comprises:
a board housing portion that can house said power supply board therein, the board housing portion being open in one of two directions that are orthogonal to a direction in which said power supply board is inserted into said relay connector on a plane of said power supply board and being closed in at least the other one of said two directions and on a side facing said chassis; and
a pair of elastic pieces that can establish an electrical connection while elastically clamping each of the terminals in locations of said board housing portion that respectively face said terminal when said power supply board engage said relay connectors.

7. The illumination device according to claim 6, wherein a plurality of said relay connectors are disposed so as to be aligned along at least one side of said chassis, and
wherein the openings of said board housing portions of respective said relay connectors are facing in the same direction.

8. The illumination device according to claim 1, wherein said board housing portion has an inviting surface on the inside of an edge of the opening on the side from which said power supply board is inserted, the inviting surface having an inclination that guides said power supply board to the interior of said board housing portion.

9. A display device comprising the illumination device according to claim 1 and a display panel that performs display by utilizing light from said illumination device.

10. The display device according to claim 9, wherein said display panel is a liquid crystal panel formed by sealing a liquid crystal between a pair of substrates.

11. A television reception device comprising the display device according to claim 9.
